(19) United States
(12) Patent Application Publication
(10) Pub. No.: US 2020/0060102 A1
(43) Pub. Date: Feb. 27, 2020

(54) GAS PERMEABLE FLOWERPOT

(71) Applicant: Renchsand Eco-Environment Protection Science and Technology Co., Ltd., Anhui (CN)

(72) Inventor: Shengyi Qin, Beijing (CN)

(73) Assignee: Renchsand Eco-Environment Protection Science and Technology Co., Ltd., Anhui (CN)

(21) Appl. No.: 16/082,043

(22) PCT Filed: Mar. 25, 2016
(86) PCT No.: PCT/CN2016/077361

§ 371 Date: Sep. 4, 2018

(30) Foreign Application Priority Data
Mar. 2, 2016 (CN) 201610115831.2

(51) Int. Cl. A01G 9/04; A01G 9/02

(52) U.S. Cl. CPC A01G 9/042; A01G 2009/003; A01G 9/02

(57) ABSTRACT

A gas permeable flowerpot (100), comprising: a tray (10), a flowerpot body (30), and a bottom plate (50). The tray (10) comprises an accommodating trough (10A) for accumulating water; the flowerpot body (30) is filled with soil; the flowerpot body (30) is provided with a plurality of stacked hollow subunits (32); the soil in each hollow subunit (32) is gas permeable; the bottom plate (50) is made of a micro-porous water absorbing material and comprises a water permeable plate (51) and a water absorbing column (52) which extends downwardly out from the water permeable plate (51); the soil is in contact with the water permeable plate (51), and the water absorbing column (52) extends into the accommodating trough (10A). Because of the water permeability of the water permeable plate (51), excessive water can flow through the water permeable plate (51) into the tray (10) to prevent roots from being eroded by water. In addition, the water absorbing column (52) extends into the tray (10) to upwardly absorb and continuously supplement the soil and roots with moisture.

### TECHNICAL FIELD

The present invention relates to flowerpots, in particular to a gas permeable flowerpot which can prevent roots of potted plants from being eroded and can retain water for the potted plants.

BACKGROUND ART

In recent years, due to increased air pollution, people's requirements for the air quality of living spaces have become higher and higher.

Studies have shown that indoor air pollutants mainly include the following six types of pollutants, including benzene, formaldehyde, phthalates, trichloroethylene, toluene and ammonia. At present, in domestic civil building standards, the indoor formaldehyde content should not be higher than 0.08 mg per cubic meter, the indoor benzene content should not be higher than 0.09 mg per cubic meter, and the indoor ammonia content should not be higher than 0.2 mg per cubic meter.

In order to improve the air quality, people have moved various kinds of plants into rooms, plants such as tigertail orchid, monstera, spathiphyllum, dracaena marginata, ficus benjamina, bracketplant, scindapsus aureus, epipremnum aureum, adiantum, and aglaonema commutatum are planted in pots and placed indoors. These plants have been shown to have a strong ability to absorb indoor air pollutants; for example, scindapsus aureus can absorb benzene, trichloroethylene, formaldehyde and so on.

However, the inventors of the present invention found that the moist potting soil can adsorb the pollution gas such as formaldehyde in the air, and therefore keeping the potting soil well ventilated and maintaining a certain degree of wetness are important for the plant to absorb indoor air pollutants; however, it is hard for the current flower pots to make the soil gas permeable and maintain the soil at a certain degree of wetness. People always water too much to cause erosion of roots or forget to water the plants to cause the plants to dry up, which is very inconvenient.

### SUMMARY OF THE INVENTION

In view of this, it is necessary to provide a gas permeable flowerpot which can prevent roots of potted plants from being eroded and can retain water for the potted plants. A gas permeable flowerpot comprises a tray, a flowerpot body, and a bottom plate. The tray comprises an accommodating trough for accumulating water; the flowerpot body is provided with a plurality of stacked hollow subunits which are filled with soil; each of the hollow subunits comprises an upper edge and a lower edge respectively at two ends; a lower edge of a hollow subunit in an upper layer of adjacent hollow subunits is positioned lower than an upper edge of a hollow subunit in a lower layer of the adjacent hollow subunits, and the lower edge of the hollow subunit in the upper layer is closer to a centerline of the flowerpot body than the upper edge of the hollow subunit in the lower layer so that a gap is formed between said lower edge and said upper edge; the bottom plate is made of a micro-porous water absorbing material and comprises a water permeable plate and water absorbing column which extends downwardly out from the water permeable plate; the soil is in contact with the water permeable plate, and the water absorbing column extends downwardly into the accommodating trough.

Compared with the prior art, in the gas permeable flowerpot provided by an embodiment of the present invention, on one hand, a lower edge of a hollow subunit in an upper layer of adjacent hollow subunits is positioned lower than an upper edge of a hollow subunit in a lower layer of the adjacent hollow subunits so that a gap is formed between said lower edge and said upper edge, and water can be prevented from flowing out of the gap when the potted plants are watered, and water flows from the hollow subunit in the upper layer (and the soil therein) to the hollow subunit in the lower layer (and the soil therein) and finally flows into the accommodating trough, thereby preventing the root erosion of the potted plants and increasing the contact of the soil at the edge of each layer with the air, that is, increasing the gas permeability of soil at each layer; on the other hand, the water permeable plate contacts the soil (and the roots of the plants), and the water absorbing column extends into the accumulated water in the flowerpot body and therefore can upwardly absorb and continuously supplement the soil and roots with moisture to prevent the plants from dying for drought. The moist potting soil can absorb the pollution gas such as formaldehyde in the air, thereby maximally improving the plant's absorption of gaseous pollutants and improving the ambient air quality.

### BRIEF DESCRIPTION OF THE DRAWINGS

In order to make the technical solution of the present invention more clear, drawings to be used in embodiments will be described briefly hereinafter. Obviously, drawings used in the following description are merely some embodiments of the present invention. Those skilled in the art also can conclude other drawings based on these drawings without paying creative labor.

FIG. 1 is a first-prospective exploded view of a gas permeable flowerpot according to the first embodiment of the present invention;

FIG. 2 is a second-perspective schematic structure diagram of the gas permeable flowerpot shown in FIG. 1;

FIG. 3 is a schematic diagram showing the assembled structure of the gas permeable flowerpot shown in FIG. 1;

FIG. 4 is a schematic cross-sectional view of the gas permeable flowerpot shown in FIG. 3.

FIG. 5 is a schematic view of soil in the gas permeable flowerpot shown in FIG. 3 and the working operation of the soil.

FIG. 6 is a schematic structure diagram of a variant modification of the gas permeable flowerpot shown in FIG. 1;

FIG. 7 is an exploded view of a gas permeable flowerpot according to the second embodiment of the present invention;

FIG. 8 is a schematic diagram showing the assembled structure of the gas permeable flowerpot shown in FIG. 7; and

FIG. 9 is a schematic structure diagram of the tray of the gas permeable flowerpot shown in FIG. 7.

### DETAILED DESCRIPTION OF EMBODIMENTS

The technical solutions in embodiments of the present invention will be described clearly and completely hereinafter with reference to the accompanying drawings in the embodiments of the present invention.

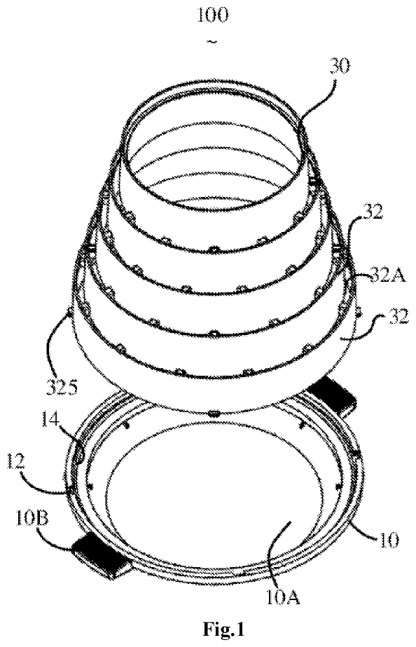

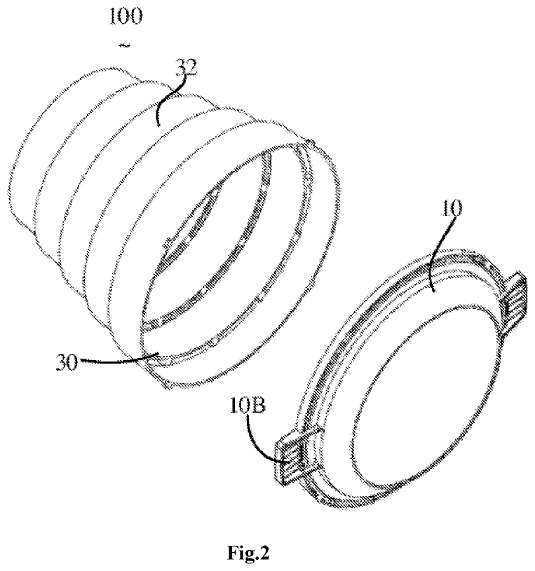

Referring to FIGS. 1-4, the first embodiment of the present invention provides a gas permeable flowerpot 100, comprising a tray 10, a flowerpot body 30, and a bottom plate 50.

The tray 10 has a round tray and comprises an accommodating trough (10A) for accumulating water. In this embodiment, the tray 10 further comprises left and right handles 10B extending from the lateral edges so that people can hold the handles 10B to move the flowerpot 100 and place it in different positions, such as a window sill, a balcony and the like. Each of the handles 10B also has a rough surface for the anti-slip purpose. In this embodiment, the tray 10 is made of a transparent material, such as glass, to facilitate the user to view the water accumulated therein to determine whether or not to water the potted plants, thereby preventing the plants from drying out. In other modified embodiments, the tray 10 may be made of other materials, for example transparent plastics, such as polymethyl methacrylate (acrylic), and may also have other shapes, such as a hollow cylinder, and a circular truncated cone, which is not limited to specific embodiments.

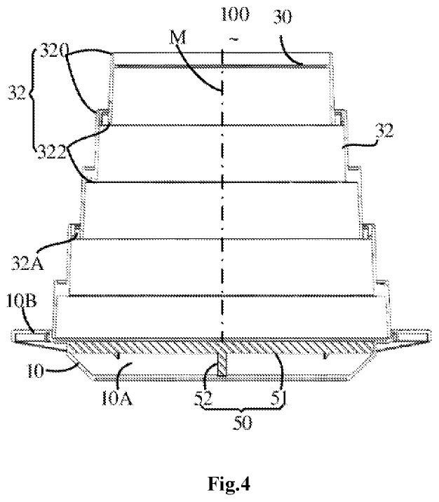

Further referring to FIG. 4, the flowerpot body 30 is used for accommodating soil and plant roots. In the embodiment, the outer diameter of the flowerpot body 30 gradually decreases from the water tray 10 away from the water tray 10. Specifically, the flowerpot body 30 comprises a plurality of hollow subunits 32 of which the outer diameters are gradually increased, and the flowerpot body 30 is formed by stacking the plurality of hollow subunits 32. Each of the hollow subunits 32 is in the shape of a hollow cylinder, and each of the hollow subunits 32 comprises an upper edge 320 and a lower edge 322 at two ends thereof, the upper edge 320 is adjacent to the top of the hollow subunit 32, the lower edge 322 is adjacent to the bottom of the hollow subunit 32, and a connection structure is disposed at the inner side of the upper edge 320 and the outer side of the lower edge 322, and the lower edge 322 of a hollow subunit 32 in an upper layer and the upper edge 320 of a hollow subunit 32 in a lower layer are integrally formed and connected.

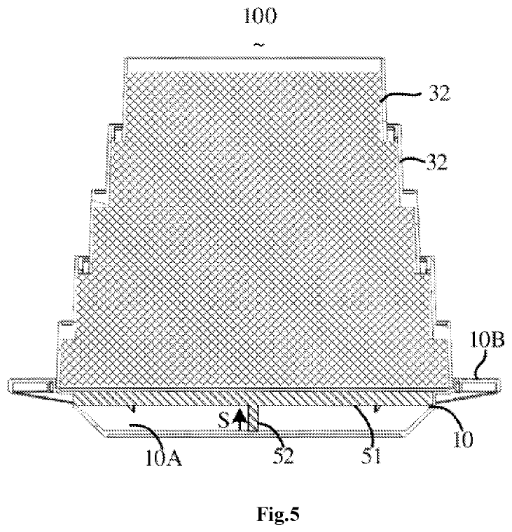

As shown in FIG. 4, the lower edge 322 of a hollow subunit 32 in an upper layer of adjacent hollow subunits 32 is positioned lower than the upper edge 320 of a hollow subunit 32 in a lower layer of the adjacent hollow subunits 32, and the lower edge 322 of the hollow subunit 32 in the upper layer is closer to a centerline M of the flowerpot body 30 than the upper edge 320 of the hollow subunit in the lower layer so that a gap 32A is formed between said lower edge and said upper edge. In such a way, when watering begins from the soil in a hollow subunit 32 at the top, the accumulated water can flow from a hollow subunit 32 in an upper layer (and the soil therein) to a hollow subunit 32 in a lower layer (and the soil therein), does not flow out of the gap 32A, and finally flows into the tray 10 (referring to FIGS. 4 and 5), thereby avoiding the root erosion of the potted plants and increasing the contact of the soil at the edge of each layer with the air, that is, increasing the gas permeability of the soil at each layer.

It should be noted that a lower edge 322 of a hollow subunit at the bottom and an inner edge of the tray 10 may be set in a size to be adapted to each other, and a snap joint structure or a screw-threaded hole structure may be disposed between the hollow subunit located at the bottom and the tray for assembly and disassembly.

In this embodiment, as shown in FIG. 1, four projections 325 are arranged on the lower edge 322 of the hollow subunit at the bottom, i.e., the hollow subunit 32 closest to the tray 10; correspondingly, the inner edge of the tray 10 is provided with four guiding grooves 12 and an annular inner groove 14 which are adapted to fit the projections, wherein the four guiding grooves 12 are communicated with the annular inner groove 14; in installation, after the four protrusions 325 are guided into the guiding grooves 12, the tray 10 and the flowerpot body 30 are relatively rotated, so that the four protrusions 325 slid into the annular inner groove 14 to achieve the connection of the tray 10 and the flowerpot body 30.

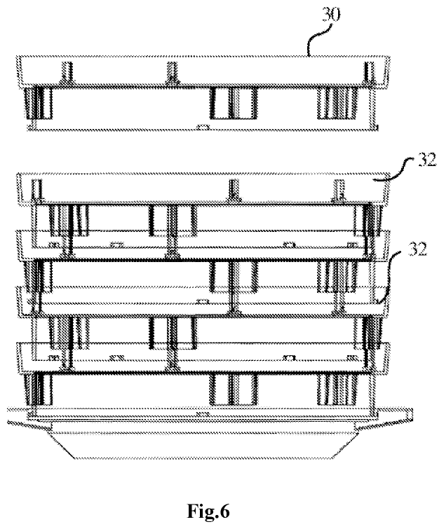

In other modified embodiments, as shown in FIG. 6, the flowerpot body 30 may be in other forms, one of which is a hollow cylindrical integral structure, which is also formed by stacking hollow subunits 32, but all the hollow subunits 32 are the same in size.

Further, for example, in the flowerpot body 30 formed by stacking the plurality of hollow subunits 32 as shown in this embodiment, the connection manner between the adjacent hollow subunits 32 is not limited to the integral structure, and they are fastened by snap-fit connection or threaded connection, which is not limited to the specific embodiment.

In this embodiment, the flowerpot body 30 is made of plastic. Of course, it may also be made of other materials such as ceramics, which is not limited to the specific embodiment.

The bottom plate 50 comprises a water permeable plate 51 and a water absorbing column 52. The water permeable plate 51 is in the form of a circular thin plate in this embodiment, and the water absorbing column 52 extends downward from a direction perpendicular to the water permeable plate 51.

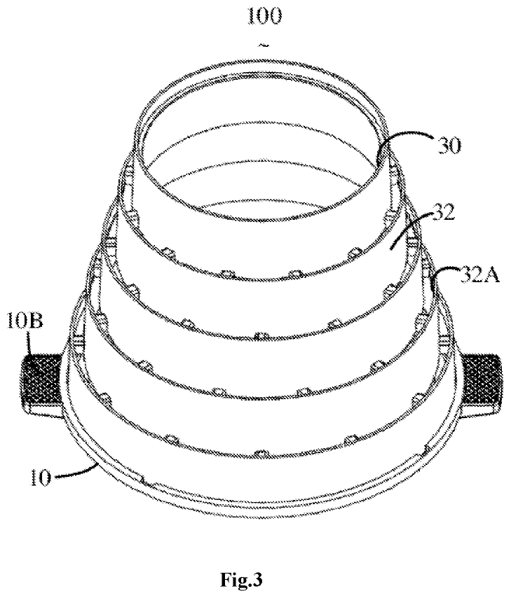

As shown in FIG. 3 and FIG. 4, the soil is in contact with the water permeable plate 51, and the water absorbing column 52 extends into the accommodating trough 10A. It can be understood that in one embodiment, the soil may be carried on the water permeable plate 51 with a partial weight.

Specifically, the bottom plate 50 is made of a microporous water absorbing material, such as a microporous plastic, a microporous ceramic, and a microporous sand-based material.

As shown in FIG. 5, in use, on one hand, the waterproof gas permeable flowerpot body 30 is gas permeable but can avoiding overflowing of water during watering; when people water potted plants, water can flow from the upper hollow subunit 32 (and the soil therein) to the lower hollow subunit 32 (and the soil therein), does not flow out of the gap 32A, and finally flows into the tray 10 (referring to FIGS. 4 and 5), thereby avoiding the root erosion of the potted plants and increasing the contact of the soil at the edge of each layer with the air, that is, increasing the gas permeability of the soil at each layer. More importantly, the water absorbing column 52 at this time can absorb water from the bottom up (see the direction S shown in FIG. 5), thereby replenishing water to the potting soil and plant roots to prevent the plants from drying out. The moist potting soil can absorb the pollution gas such as formaldehyde in the air, thereby achieving the objective of maximally improving the plant's absorption of gaseous pollutants.

In addition, in this embodiment, the tray 10 is made of a transparent material, such as glass, to facilitate the user to view the water accumulated therein to determine whether or not to water potted plants, thereby further preventing the plants from drying out.

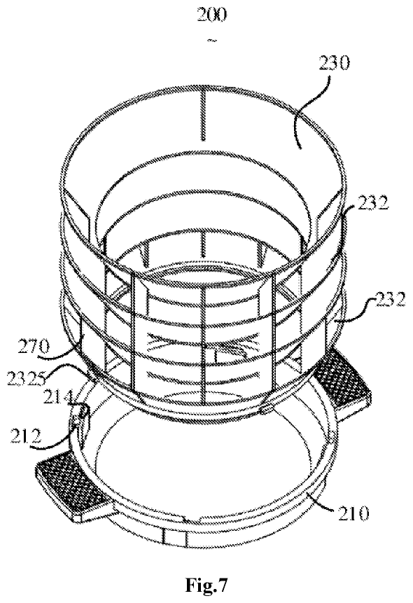

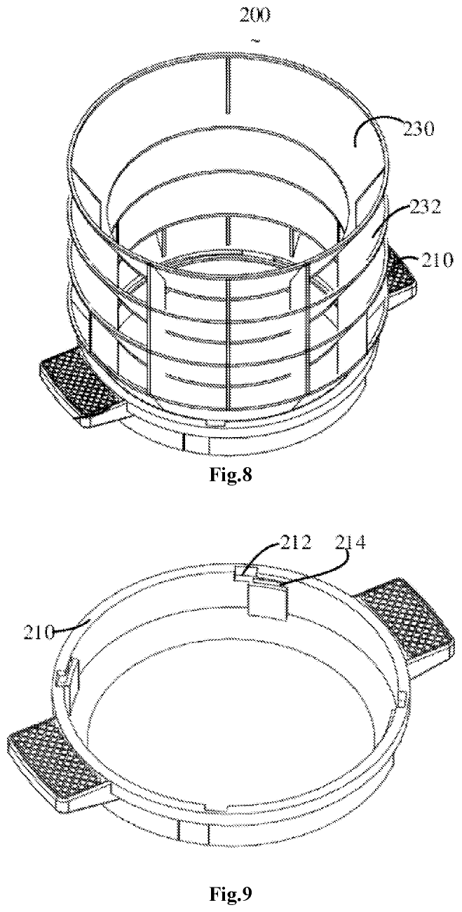

Referring to FIG. 7 and FIG. 8, the second embodiment of the present invention provides a gas permeable flowerpot 200, comprising a tray 210, a flowerpot body 230, and a bottom plate (not shown).

The gas permeable flowerpot 200 is similar in structure to the gas permeable flowerpot 100 provided in the first embodiment, except that the outer contour of each hollow subunit 232 is in the shape of an inverted circular truncated cone and the hollow subunits are stacked up to form the flowerpot body 230 and the adjacent hollow subunits 232 are integrally connected by reinforcing ribs 270. The flowerpot body 230 is formed by fastening a plurality of hollow subunits 233 by snaps or screws, and has a cylindrical outer contour as a whole.

In addition, as shown in FIG. 7, four projections 2325 are arranged on a lower edge of a hollow subunit 232 at the bottom, i.e., the hollow subunit 232 closest to the tray 210; correspondingly, the inner edge of the tray 10 is provided with four guiding grooves 212 and four inner grooves 214 adapted to the projections (referring to FIG. 9), wherein the four guiding grooves 212 are communicated with the four inner grooves 214; in installation, after the four protrusions 2325 are guided into the guiding grooves 212, the tray 210 and the flowerpot body 230 are relatively rotated, so that the four protrusions 2325 slid into the inner grooves 214 to achieve the connection of the tray 210 and the flowerpot body 230, as shown in FIG. 8.

In this embodiment, the waterproof gas permeable flowerpot body 230 is gas permeable but can avoid overflowing of water during watering; when people water potted plants, water can flow from a hollow subunit 232 in an upper layer (and the soil therein) to a hollow subunit 232 in a lower layer (and the soil therein), does not flow out of the gap between the two hollow subunits, and finally flows into the tray 210, thereby avoiding the root erosion of the potted plants and increasing the contact of the soil at the edge of each layer with the air, that is, increasing the gas permeability of the soil at each layer.

The preferred embodiments are described as above. It should be noted that for the person of ordinary skill in the art, several improvements and modifications also may be made without departing from the principles of the present invention, and these improvements and modifications also should be considered as falling within the protection scope of the present invention.

1. A gas permeable flowerpot, comprising:
a tray having an accommodating trough for accumulating water;
a flowerpot body, wherein the flowerpot body is provided with a plurality of stacked hollow subunits which are filled with soil; each of the hollow subunits comprises an upper edge and a lower edge respectively at two ends; a lower edge of a hollow subunit in an upper layer of adjacent hollow subunits is positioned lower than an upper edge of a hollow subunit in a lower layer of the adjacent hollow subunits, and the lower edge of the hollow subunit in the upper layer is closer to a centerline of the flowerpot body than the upper edge of the hollow subunit in the lower layer so that a gap is formed between said lower edge and said upper edge; and
a bottom plate which is made of a micro-porous water absorbing material, wherein the bottom plate comprises a water permeable plate and a water absorbing column which extends downwardly from the water permeable plate, the soil is in contact with the water permeable plate, and the water absorbing column extends downwardly into the accommodating trough.

2. The gas permeable flowerpot according to claim 1, wherein the hollow subunits are in the shape of hollow cylinders, and outer diameters of the plurality of hollow subunits gradually decrease in a direction away from the tray.

3. The gas permeable flowerpot according to claim 1, wherein the hollow subunits are in the shape of hollow cylinders, and outer diameters of the plurality of hollow subunits are the same.

4. The gas permeable flowerpot according to claim 1, wherein the outer contours of the hollow subunits are in the shape of inverted circular truncated cones.

5. The gas permeable flowerpot according to claim 2, wherein the plurality of hollow subunits are fastened to each other by snap-fit connection or threaded connection, or are integrally formed.

6. The gas permeable flowerpot according to claim 1, wherein a lower edge of the hollow subunit closest to the tray is provided with protrusions, and an inner edge of the tray is provided with guiding grooves and an inner groove which are adapted to fit the protrusions and are communicated with each other.

7. The gas permeable flowerpot according to claim 1, wherein the micro-porous water absorbing material includes microporous plastics, microporous ceramics, microporous sand-based material.

8. The gas permeable flowerpot according to claim 1, wherein the tray is made of a transparent material.

9. The gas permeable flowerpot according to claim 8, wherein the tray is made of glass or transparent plastics.

10. The gas permeable flowerpot according to claim 1, wherein the tray further comprises two handles extending from lateral edges of the tray.

11. The gas permeable flowerpot according to claim 3, wherein the plurality of hollow subunits are fastened to each other by snap-fit connection or threaded connection, or are integrally formed.

12. The gas permeable flowerpot according to claim 4, wherein the plurality of hollow subunits are fastened to each other by snap-fit connection or threaded connection, or are integrally formed.

13. A gas permeable flowerpot, comprising:
a tray having an accommodating trough for accumulating water;
a flowerpot body including a plurality of stacked hollow subunits which can be filled with soil, each of the hollow subunits comprises: an upper edge and a lower edge respectively at two ends; and a lower edge of a hollow subunit in an upper layer of adjacent hollow subunits is positioned lower than an upper edge of a hollow subunit in a lower layer of the adjacent hollow subunits, and the lower edge of the hollow subunit in the upper layer is closer to a centerline of the flowerpot body than the upper edge of the hollow subunit in the lower layer so that a gap is formed between said lower edge and said upper edge; and
a bottom plate which is made of a micro-porous water absorbing material, wherein the bottom plate comprises a water permeable plate and a water absorbing column which extends downwardly from the water permeable plate, so that when the subunits are filled with soil, the soil is in contact with the water permeable plate, and the water absorbing column extends downwardly into the accommodating trough.
